(19) United States
(12) Patent Application Publication
(10) Pub. No.: US 2026/0158706 A1
(43) Pub. Date: Jun. 11, 2026

(54) BIOMASS-BASED FIBER COMPOSITE MATERIAL AND PREPARATION METHOD THEREFOR AND USE THEREOF

(71) Applicant: SAIC GM Wuling Automobile CO., Ltd, Liuzhou (CN)

(72) Inventors: Xiaobin ZHAO, Liuzhou (CN); Wei LI, Liuzhou (CN); Mengdie DENG, Liuzhou (CN); Changye LIU, Liuzhou (CN); Jiande QI, Liuzhou (CN); Qichang GUO, Liuzhou (CN); Limei HE, Liuzhou (CN)

(73) Assignee: SAIC GM Wuling Automobile CO., Ltd, Liuzhou (CN)

(21) Appl. No.: 19/356,001

(22) Filed: Oct. 10, 2025

(30) Foreign Application Priority Data
Nov. 21, 2024 (CN) 202411672998X

(51) Int. Cl. B29B 11/16; B29C 43/00; B29C 43/20; B29K 23/00; B29K 105/08; B29K 307/04; B29K 311/14; C08K 3/02; C08K 3/04; C08L 23/12; C10B 53/02; C10B 57/08

(52) U.S. Cl. CPC B29B 11/16; B29C 43/006; B29C 43/206; C08K 3/02; C08K 3/04; C08L 23/12; C10B 53/02; C10B 57/08; B29K 2023/12; B29K 2105/0845; B29K 2307/04; B29K 2311/14; C08K 2003/023

(57) ABSTRACT

The present disclosure provides a biomass-based fiber composite material and a preparation method therefor and use thereof. In the present disclosure, cypress is treated to extract the fibers therein, cypress stems are treated by high-temperature pyrolysis reaction in a gasification furnace to obtain a silicon-carbon material. The extracted fibers are mixed with a silicon-carbon material by a surface coating method, and then dried, compacted, cured and woven into precursors, which are then woven into cloth. The cloth is then molded into the required product in the corresponding size according to the performance requirements of different products. The present disclosure makes full use of the high strength, moisture absorption and dehumidification, heat insulation, sound insulation and other properties of cypress fibers; combines the cypress fibers with the silicon-carbon material made from cypress stems to mix, dry and press them.

### CROSS-REFERENCE TO RELATED APPLICATIONS

The application claims priority to Chinese patent application No. 202411672998X, filed on Nov. 21, 2024, the entire contents of which are incorporated herein by reference.

### TECHNICAL FIELD

The present disclosure relates to the technical field of composite materials, and in particular to a biomass-based fiber composite material and a preparation method therefor and use thereof.

### BACKGROUND

With the continuous development of the automotive industry, environmental issues have become increasingly prominent, especially for materials in the car that are in direct contact with drivers and passengers. In the prior art, most interior parts are made of plastic materials such as PVC, PS, and PP (polypropylene resin). Such industrial plastics are heavily dependent on non-renewable resources such as petroleum. Not only are they environmentally unfriendly, but the odors they emit often contain certain ingredients that are harmful to the human body, failing to meet regulatory requirements. Long-term exposure will damage human health.

Due to the defects of the plastics such as PVC, PS, PP (i.e. polypropylene resin) currently used in automobile interior parts, it is necessary to improve them.

### SUMMARY

In view of this, the present disclosure provides a biomass-based fiber composite material and use thereof to solve the defects in the prior art.

In a first aspect, the present disclosure provides a method for preparing a biomass-based fiber composite material, including the following steps:
soaking cypress stem bark in a sodium hydroxide solution;
adding a sodium silicate degumming agent to the soaked cypress stem bark, and steaming at 120-160° C. to decompose the colloid in the fiber;
adding a solution containing sodium sulfite and compound sodium phosphate to the steamed cypress stem bark, to obtain cypress fiber;
adding the cypress fiber to a bulking agent containing a metal oxide and subjecting to bulking treatment at 35-60° C.;
adding a qualitative agent to the bulked cypress fiber;
drying the cypress fiber after qualitative treatment;
pyrolyzing the cypress stem at a high temperature to obtain a silicon-carbon material;
   grinding the silicon-carbon material into powder to obtain carbon powder;
   mixing the carbon powder with a polypropylene resin, adding ethanol as a solvent, then adding polyacrylate as a dispersant, stirring, to obtain a slurry;
   coating the slurry to the surface of the dried cypress fiber, curing and spinning into fiber precursors; and
   weaving the fiber precursors into fiber cloth through a weaving process.

Preferably, the cypress stem bark is soaked in a sodium hydroxide solution for 30-60 hours; the mass concentration of the sodium hydroxide solution is 15-20 g/L.

Preferably, a sodium silicate degumming agent is added to the soaked cypress stem bark, and in the step of steaming at 120-160° C., the steaming time is 4-8 hours, and the sodium silicate is added in the form of a sodium silicate solution with a concentration of 2-4 g/L.

Preferably, a solution containing sodium sulfite and compound sodium phosphate is added to the steamed cypress stem bark, and the mixture is allowed to stand for 20-30 hours to obtain cypress fiber;
the solution containing sodium sulfite and compound sodium phosphate is prepared by adding sodium sulfite and compound sodium phosphate to water to obtain a solution containing sodium sulfite and composite sodium phosphate, wherein the concentration of sodium sulfite is 1-4 g/L and the concentration of compound sodium phosphate is 1-4 g/L.

Preferably, the fiber is added to a bulking agent containing a metal oxide and subjected to bulking treatment at 35-60° C. for 2-3 hours; the bulking agent is prepared by adding MgO to water to obtain a bulking agent, wherein the MgO concentration is 10-15 g/L.

Preferably, a qualitative agent is added to the bulked cypress fiber for treatment at 25-30° C. for 25-30 minutes, wherein, the qualitative agent is prepared by adding CuCl₂ to ammonia water to obtain a copper ammonia solution, i.e., the qualitative agent; the copper ion concentration in the copper ammonia solution is 0.5-1.5 mol/L.

Preferably, the cypress stem is pyrolyzed at a high temperature to obtain a silicon-carbon material, which specifically includes the following steps:
pyrolyzing the cypress stem at 600-700° C. for 2-4 hours under an inert atmosphere to obtain a silicon-carbon material;
the inert atmosphere includes at least one of nitrogen, helium, neon and argon;
in the step of mixing the carbon powder with a polypropylene resin, the mass ratio of the carbon powder to the polypropylene resin is 1:(1-3), the mass ratio of the carbon powder to the solvent ethanol is 1:(38-42), and the mass ratio of the carbon powder to the dispersant polyacrylate is (40-42):1.

In a second aspect, the present disclosure further provides a biomass-based fiber composite material prepared by the aforementioned preparation method.

In a third aspect, the present disclosure further provides use of a biomass-based fiber composite material prepared by the preparation method or the biomass-based fiber composite material in the preparation of automotive interior parts.

Preferably, the biomass-based fiber composite material is placed in a mold, then a polypropylene resin is laid on the biomass-based fiber composite material, and then the biomass-based fiber composite material is laid on the polypropylene resin, and the operation is repeated so that the biomass-based fiber composite material and the polypropylene resin are arranged alternately in sequence; the mold is then softened at a temperature of 200-220° C. for 3-7 minutes, and finally maintained at a pressure of 12.5-15 MPa for 60-80 seconds to obtain automotive interior parts.

In the present disclosure, compared with the prior art, the biomass-based fiber composite material, preparation method therefor and use thereof have the following beneficial effects:

The cypress fiber material obtained after treatment according to the preparation method of the biomass-based fiber composite material can fully utilize the properties of cypress fiber such as high strength, moisture absorption and removal, heat insulation and sound insulation, and is mixed with the silicon-carbon material made from the cypress stem, dried, and pressed. The composite material has wear resistance due to the carbon element, and also has antistatic and odor-eliminating functions. When the composite material prepared by the present disclosure is used as a lower baffle of the air-conditioning box in an automobile, the cross-section of the cypress fiber exhibits a multi-level pore activated carbon structure with interconnected micropores and macropores when observed under an electron microscope. The porous features provide strong adsorption, allowing for rapid absorption and evaporation of moisture, which is beneficial to keeping the lower baffle dry, and absorbing noise inside the vehicle.

### BRIEF DESCRIPTION OF DRAWINGS

In order to more clearly illustrate the embodiments of the present disclosure or the technical solutions in the prior art, the following briefly describes the drawings required for describing the embodiments or the prior art. Obviously, the drawings described below are only some embodiments of the present disclosure. Persons of ordinary skill in the art can easily derive other drawings based on these drawings without creative effort.

FIG. 1 is a scanning electron microscope (SEM) image of the slurry coated on the surface of dry cypress fiber in the step S10 of Example 1 and cured at room temperature;

FIG. 2 is a SEM image of the carbon powder prepared in the step S8 of Example 1;

FIG. 3 is a physical picture of an automobile interior part (specifically, a lower baffle of an air conditioning box) prepared by the preparation method of Example 1;

FIG. 4 is a SEM image of the cypress fiber in the step S6 of Example 1; and

FIG. 5 is a physical picture of the carbon powder prepared in the step S8 of Example 1.

### DETAILED DESCRIPTION OF THE EMBODIMENTS

The technical solutions in the embodiments of the present disclosure will be clearly and completely described below in conjunction with the embodiments of the present disclosure. Obviously, the described embodiments are only a part of the embodiments of the present disclosure, rather than all of the embodiments thereof. All other embodiments obtained by persons of ordinary skill in the art based on the embodiments of the present disclosure without creative efforts shall fall within the protection scope of the present disclosure.

It should be noted that the order in which the following embodiments are described is not intended to limit the preferred order of the embodiments. Furthermore, in the description of the present application, the term “including” means “including but not limited to”. Various embodiments of the present disclosure may be presented in a range format. It should be understood that the description in a range format is merely for convenience and brevity and should not be construed as a rigid limitation on the scope of the present disclosure. Accordingly, the description of a range should be considered to have specifically disclosed all possible subranges as well as individual numerical values within that range. For example, description of a range from 1 to 6 should be considered to have specifically disclosed sub-ranges, such as from 1 to 3, from 1 to 4, from 1 to 5, from 2 to 4, from 2 to 6, from 3 to 6, etc., as well as individual numbers within the range, such as 1, 2, 3, 4, 5, and 6, regardless of the range. Additionally, whenever a numerical range is indicated herein, it is meant to include any cited numeral (fractional or integral) within the indicated range.

The embodiments of the present disclosure provide a method for preparing a biomass-based fiber composite material, including the following steps:
S1, soaking cypress stem bark in a sodium hydroxide solution;
S2, adding a sodium silicate degumming agent to the soaked cypress stem bark, and steaming at 120-160° C. to decompose the colloid in the fiber;
S3, adding a solution containing sodium sulfite and compound sodium phosphate to the steamed cypress stem bark, to obtain cypress fiber;
S4, adding the cypress fiber to a bulking agent containing a metal oxide and subjecting to bulking treatment at 35-60° C.;
S5, adding a qualitative agent to the bulked cypress fiber;
S6, drying the cypress fiber after qualitative treatment;
S7, pyrolyzing the cypress stem at a high temperature to obtain a silicon-carbon material;
S8, grinding the silicon-carbon material into powder to obtain carbon powder;
S9, mixing the carbon powder with a polypropylene resin, adding ethanol as a solvent, then adding polyacrylate as a dispersant, stirring, to obtain a slurry;
S10, coating the slurry to the surface of the dried cypress fiber, curing and spinning into fiber precursors; and
S11, weaving the fiber precursors into fiber cloth through a weaving process.

In some embodiments, the cypress stem bark is soaked in a sodium hydroxide solution (specifically, an aqueous sodium hydroxide solution) for 30-60 hours; the mass concentration of the sodium hydroxide solution is 15-20 g/L.

In some embodiments, cypress stems are taken, branches, leaves, and surface impurities are removed, and the cypress stem bark is cleaned and cut into 3-5 cm in length.

In some embodiments, a sodium silicate degumming agent is added to the soaked cypress stem bark, and in the step of steaming at 120-160° C., the steaming time is 4-8 hours; the sodium silicate is added in the form of a sodium silicate solution (aqueous solution) with a concentration of 2-4 g/L.

In some embodiments, a solution containing sodium sulfite and compound sodium phosphate is added to the steamed cypress stem bark, and the mixture is allowed to stand at room temperature (23±2° C.) for 20-30 hours to obtain cypress fiber.

In some embodiments, the solution containing sodium sulfite and compound sodium phosphate is prepared by adding sodium sulfite and compound sodium phosphate to water to obtain a solution containing sodium sulfite and composite sodium phosphate, wherein the concentration of sodium sulfite is 1-4 g/L and the concentration of compound sodium phosphate is 1-4 g/L.

In some embodiments, the fiber is added to a bulking agent containing a metal oxide and subjected to bulking treatment at 35-60° C. for 2-3 hours; the bulking agent is prepared by adding MgO to water to obtain a bulking agent, wherein the MgO concentration is 10-15 g/L.

In some embodiments, a qualitative agent is added to the bulked cypress fiber for treatment at 25-30° C. for 25-30 minutes, wherein, the qualitative agent is prepared by adding CuCl₂ to ammonia water to obtain a copper ammonia (Cu(NH₃)₄](OH)₂)solution, i.e., the qualitative agent; the copper ion concentration in the copper ammonia solution is 0.5-1.5 mol/L.

In some embodiments, in the step of drying the cypress fiber after the qualitative treatment, the breaking strength of a single cypress fiber is 5.2-6.9 cN/dtex (centinewtons per dtex, a unit of breaking strength, the maximum tensile force a fiber can withstand), and the elongation at break is 8-10%.

In some embodiments, the cypress stem is pyrolyzed at a high temperature to obtain a silicon-carbon material, which specifically includes the following steps:
pyrolyzing the cypress stem at 600-700° C. for 2-4 hours under an inert atmosphere to obtain a silicon-carbon material;
the inert atmosphere includes at least one of nitrogen, helium, neon and argon.

In some embodiments, the silicon-carbon material is ground into powder with a particle size of 50-200 μm to obtain carbon powder.

The cypress stems are treated by high-temperature pyrolysis reaction in a gasification furnace to obtain a silicon-carbon material. This material microscopically exhibits a multi-level pore activated carbon structure with interconnected micropores and macropores. The porous features provide strong adsorption, while also providing noise reduction and odor absorption capabilities.

In some embodiments, carbon powder and polypropylene resin are mixed, then ethanol is added as a solvent, and then polyacrylate is added as a dispersant, and stirred to obtain a slurry;
wherein, in the step of mixing the carbon powder and the polypropylene resin, the mass ratio of the carbon powder to the polypropylene resin is 1:(1-3), the mass ratio of the carbon powder to the solvent ethanol is 1:(38-42), and the mass ratio of the carbon powder to the dispersant polyacrylate is (40-42):1.

In some embodiments, the fiber precursors are woven into a fiber cloth through a weaving process, wherein the density of the fiber cloth is 0.7-1.1 g/cm³; the thickness of the fiber cloth is 6-10 mm.

In some embodiments, the weaving process of the fiber cloth is such that each two fiber precursors are either parallel or intersecting at multiple angles, i.e., the fiber precursors are woven through warp and weft to obtain the fiber cloth.

Based on the same inventive concept, the present disclosure also provides a biomass-based fiber composite material, which is prepared using the aforementioned preparation method.

Based on the same inventive concept, the present disclosure also provides use of a biomass-based fiber composite material prepared by the aforementioned preparation method or the aforementioned biomass-based fiber composite material in the preparation of automotive interior parts.

The specific automobile interior parts can be the lower baffle of the air-conditioning box in the automobile.

In some embodiments, a biomass-based fiber composite material is placed in a mold, and then a polypropylene resin is laid on the biomass-based fiber composite material, and then the biomass-based fiber composite material is laid on the polypropylene resin again, and the operation is repeated so that the biomass-based fiber composite material and the polypropylene resin are arranged alternately in sequence; the mold is then softened at a temperature of 200-220° C. for 3-7 minutes, and finally maintained at a pressure of 12.5-15 MPa for 60-80 seconds to obtain automotive interior parts.

Specifically, the mass ratio of the biomass-based fiber composite material to the polypropylene resin is (4-6):(4-6). The biomass-based fiber composite material and the polypropylene resin are alternately arranged in sequence until the final product meets the required surface density (600 g/m² to 1800 g/m²). The mold is then softened at a temperature of 200-220° C. for 3-7 minutes, and finally maintained at a pressure of 12.5-15 MPa for 60-80 seconds to obtain automotive interior parts.

In some embodiments, the automotive interior parts prepared in the present disclosure can also have the effects of cypress, such as invigorating the spleen and replenishing qi, dispelling wind and eliminating dampness, etc.

The present disclosure utilizes biomass-based fiber composite materials to prepare automotive interior parts, such as the lower baffle of the air-conditioning box in an automobile. The cross-section of the cypress fiber exhibits a multi-level pore activated carbon structure with interconnected micropores and macropores when observed under an electron microscope. The porous features provide strong adsorption, allowing for rapid absorption and evaporation of moisture. The use of biomass-based fiber composite materials to prepare the lower baffle of the air-conditioning box is beneficial to keeping the lower baffle dry, and absorbing noise inside the vehicle. In addition, the product has a subtle Chinese medicine aroma.

The cypress fiber material obtained after treatment in the present disclosure can fully utilize the properties of cypress fiber such as high strength, moisture absorption and removal, heat insulation and sound insulation, and is mixed with the silicon-carbon material made from the cypress stem, dried, and pressed, finally a biomass-based fiber composite material is prepared. The composite material has wear resistance due to the carbon element, and also has antistatic and odor-eliminating functions.

The biomass-based fiber composite material of the present application, the preparation method therefor and the use thereof are further described below with specific embodiments. This section further illustrates the present disclosure in conjunction with specific embodiments, but should not be construed as limiting the present disclosure. Unless otherwise specified, the technical means employed in the embodiments are conventional means well known to those skilled in the art. Unless otherwise specified, the reagents, methods and equipment used in the present disclosure are conventional reagents, methods and equipment in the art.

### Example 1

The embodiments of the present disclosure provided a method for preparing a biomass-based fiber composite material, including the following steps:
S1, cypress stems were taken, branches, leaves, and surface impurities were removed; he cypress stem bark was cleaned and cut into 3-5 cm in length; the cypress stem bark was soaked in a 20 g/L sodium hydroxide aqueous solution for 50 hours;
S2, a sodium silicate degumming agent was added to the soaked cypress stem bark, and steamed at 140° C. for 6 hours to decompose the colloid in the fiber; sodium silicate was added in the form of sodium silicate solution (aqueous solution), and the concentration of the sodium silicate solution was 3 g/L;
S3, a solution containing sodium sulfite and compound sodium phosphate was added to the steamed cypress stem bark, allowed to stand at room temperature (25° C.) for 24 hours to obtain cypress fiber; the solution containing sodium sulfite and compound sodium phosphate was prepared by adding sodium sulfite and compound sodium phosphate to water to obtain a solution containing sodium sulfite and composite sodium phosphate, wherein the concentration of sodium sulfite was 2 g/L and the concentration of compound sodium phosphate was 3 g/L;
S4, the cypress fiber was added to a bulking agent containing a metal oxide and subjected to the bulking treatment at a temperature of 45° C. for 2 hours; the bulking agent was prepared by adding MgO to water to obtain a bulking agent, wherein the MgO concentration was 12 g/L;
S 5, a qualitative agent was added to the bulked cypress fiber for treatment at 30° C. for 30 minutes, wherein, the qualitative agent was prepared by adding CuCl₂ to ammonia water to obtain a copper ammonia (Cu(NH₃)₄](OH)₂) solution, i.e., the qualitative agent; the copper ion concentration in the copper ammonia solution was 1 mol/L;
S6, the cypress fiber after qualitative treatment was dried at room temperature;
S 7, the cypress stem was prolyzed at 650° C. for 3 hours under a nitrogen atmosphere to obtain a silicon-carbon material;
S 8, the silicon-carbon material was ground into powder with a particle size of 100 μm to obtain carbon powder;
S 9, the carbon powder and the polypropylene resin were mixed in a mass ratio of 1:2, then ethanol was added as a solvent, and then polyacrylate was added as a dispersant, and stirred to obtain a slurry; the mass ratio of the carbon powder to the solvent ethanol was 1:40, and the mass ratio of the carbon powder to the dispersant polyacrylate was 40:1;
S10, the slurry was coated on the surface of dry cypress fiber, cured at room temperature, and woven into fiver precursors; and
S11, the fiber precursors were woven into a fiber cloth through a weaving process.

This embodiment also provided use of the biomass-based fiber composite material prepared in Example 1 in the preparation of automotive interior parts; specifically, the method for preparing the automotive interior parts was as follows:
the biomass-based fiber composite material was placed in a mold, then a polypropylene resin was laid on the biomass-based fiber composite material, and then the biomass-based fiber composite material was laid on the polypropylene resin, and the operation was repeated so that the biomass-based fiber composite material and the polypropylene resin were arranged alternately in sequence; the mold was then softened at 220° C. for 5 minutes, and finally maintained at a pressure of 15 MPa for 80 seconds to obtain automotive interior parts. The mass ratio of the biomass-based fiber composite material to the polypropylene resin was 5:5, and the biomass-based fiber composite material and the polypropylene resin were alternately arranged in sequence until the final product met the required surface density (1200 g/m²).

### Performance Characterization

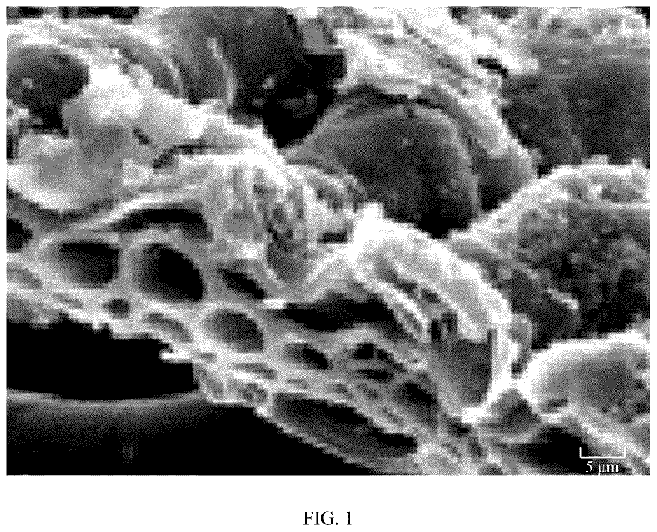

FIG. 1 showed a SEM image of the slurry coated on the surface of dry cypress fiber in the step S10 of Example 1 after curing at room temperature.

As shown in FIG. 1, the carbon powder was adsorbed on the surface of the cypress fiber, and eventually large (particle size >10 μm) honeycomb-like solids were deposited on the fiber surface. This composite material, based on cypress fibers as a matrix and enhanced with silicon-carbon particles (for reinforcement), was beneficial to improving the mechanical properties, wear resistance and anti-static properties of the fiber (high carbon content can increase the fiber stiffness and hardness, and carbon powder is a highly conductive powder material, which is beneficial to reducing surface impedance and improving anti-static ability). Furthermore, the microporous structure of the carbon powder provided pore-channel adsorption, enhancing the quality of odor and sound absorption.

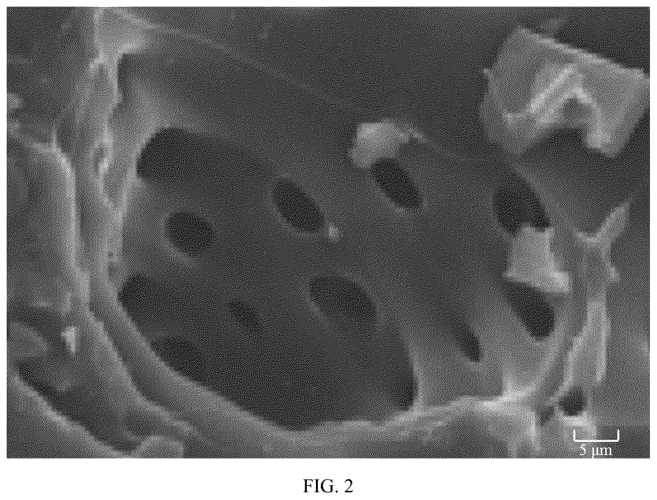

FIG. 2 showed a SEM image of the carbon powder prepared in the step S8 of Example 1.

As shown in FIG. 2, the prepared carbon powder was porous, with scaly protrusions and tiny pores on the surface. These structures significantly increased the material's specific surface area, thereby enhancing its ability to absorb sound and odors.

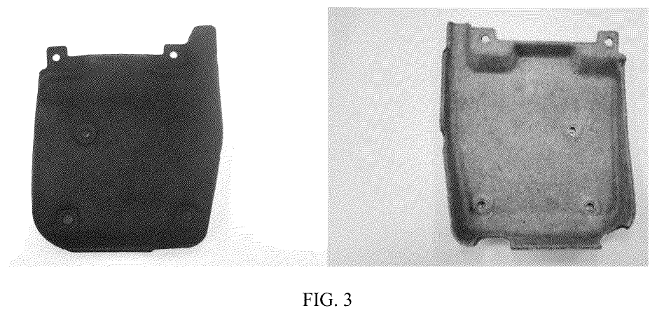

FIG. 3 showed a physical picture of an automobile interior decoration part (specifically, a lower baffle of an air-conditioning box) prepared by the preparation method of Example 1.

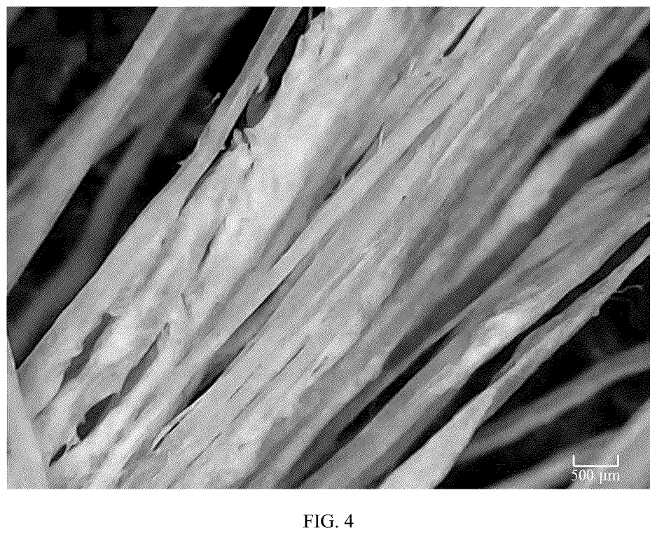

FIG. 4 showed a SEM image of the cypress fiber in the step S6 of Example 1.

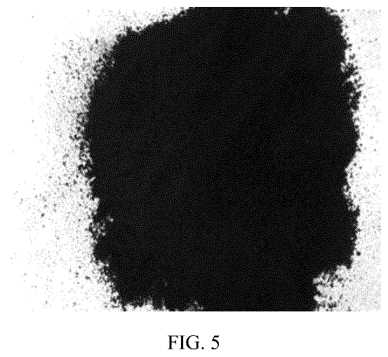

FIG. 5 showed is a physical picture of the carbon powder prepared in the step S8 of Example 1.

The automotive interior parts prepared in Example 1 had a Shore hardness of 65, while conventional automotive interior parts made with polypropylene resin have a Shore hardness of 40-50. The surface impedance of the automotive interior parts prepared in Example 1 was 1.2×10¹⁰Ω, while conventional automotive interior parts made with polypropylene resin have a surface impedance of >10¹⁶Ω. This demonstrated that the automotive interior parts prepared in accordance with the present disclosure had superior wear resistance and antistatic properties (materials with low surface impedance allow charges to flow easily on the surface, thus preventing static electricity from accumulating).

The automotive interior parts prepared in Example 1 had a strong plant fiber fragrance (traditional Chinese medicine fragrance) and a TVOC value of 765 μg/m³. In contrast, the automotive interior parts prepared using conventional polypropylene resin had a strong plastic smell and a TVOC value of 16273 μg/m³. This indicated that the automotive interior parts prepared in the present disclosure could eliminate odors. TVOC (total organic volatile compounds) is a quantitative indicator of automotive air pollution. It primarily includes small volatile molecules such as benzene, alkanes, and aromatic hydrocarbons. A higher TVOC value indicates a larger number of odor molecules entering the human respiratory system, and the worse the odor. For passenger car interior parts, TVOC is generally required to be less than 15000 μg/m³. The automobile interior parts prepared by the present disclosure had a lower TVOC value, were more environmentally friendly and less harmful to the human body.

The automotive interior parts prepared in Example 1 had a flexural strength of 50.3 MPa and a flexural modulus of 3,798 MPa, demonstrating excellent mechanical properties.

The foregoing description is merely a preferred embodiment of the present disclosure and is not intended to limit the present disclosure. Any modifications, equivalent substitutions, and improvements, etc. made within the spirit and principles of the present disclosure shall be included in the scope of protection of the present disclosure.

What is claimed is:

1. A method for preparing a biomass-based fiber composite material, comprising the following steps:
soaking cypress stem bark in a sodium hydroxide solution with a mass concentration of 15-20 g/L for 30-60 hours;
adding a sodium silicate degumming agent to the soaked cypress stem bark, and steaming at 120-160° C. to decompose the colloid in the fiber; the steaming time is 4-8 hours, and the sodium silicate is added in the form of a sodium silicate solution with a concentration of 2-4 g/L;
adding a solution containing sodium sulfite and compound sodium phosphate to the steamed cypress stem bark, and allowing the solution to stand for 20-30 hours to obtain cypress fiber; the solution containing sodium sulfite and compound sodium phosphate is prepared by adding sodium sulfite and compound sodium phosphate to water to obtain a solution containing sodium sulfite and composite sodium phosphate, wherein the concentration of sodium sulfite is 1-4 g/L and the concentration of compound sodium phosphate is 1-4 g/L;
adding the cypress fiber to a bulking agent containing a metal oxide and subjecting to bulking treatment at 35-60° C.; the bulking treatment lasts for 2-3 hours; the bulking agent is prepared by adding MgO to water to obtain a bulking agent, wherein the MgO concentration is 10-15 g/L;
adding a qualitative agent to the bulked cypress fiber for treatment at 25-30° C. for 25-30 minutes, wherein, the qualitative agent is prepared by adding CuCl₂ to ammonia water to obtain a copper ammonia solution, i.e., the qualitative agent; the copper ion concentration in the copper ammonia solution is 0.5-1.5 mol/L;
drying the cypress fiber after qualitative treatment;
pyrolyzing the cypress stem at 600-700° C. for 2-4 hours under an inert atmosphere to obtain a silicon-carbon material;
grinding the silicon-carbon material into powder to obtain carbon powder;
mixing the carbon powder with a polypropylene resin, adding ethanol as a solvent, then adding polyacrylate as a dispersant, stirring, to obtain a slurry; the mass ratio of the carbon powder to the polypropylene resin is 1:(1-3), the mass ratio of the carbon powder to the ethanol as a solvent is 1:(38-42), and the mass ratio of the carbon powder to the polyacrylate is (40-42):1;
coating the slurry to the surface of the dried cypress fiber, curing and spinning into fiber precursors; and
weaving the fiber precursors into fiber cloth through a weaving process.

2. The method for preparing the biomass-based fiber composite material according to claim 1, wherein:
the inert atmosphere comprises at least one of nitrogen, helium, neon and argon.

3. A biomass-based fiber composite material is prepared by the preparation method of claim 1.

4. The biomass-based fiber composite material of claim 3 in the preparation of automotive interior parts.

5. The use according to claim 4, wherein the biomass-based fiber composite material is placed in a mold, then a polypropylene resin is laid on the biomass-based fiber composite material, and then the biomass-based fiber composite material is laid on the polypropylene resin, and the operation is repeated so that the biomass-based fiber composite material and the polypropylene resin are arranged alternately in sequence; the mold is then softened at a temperature of 200-220° C. for 3-7 minutes, and finally maintained at a pressure of 12.5-15 MPa for 60-80 seconds to obtain automotive interior parts.
